(19) United States
(12) Patent Application Publication
(10) Pub. No.: US 2026/0019540 A1
(43) Pub. Date: Jan. 15, 2026

(54) LASER PROJECTION IMAGING DEVICE

(71) Applicant: HISENSE LASER DISPLAY CO., LTD., Shandong (CN)

(72) Inventors: Zhihao WANG, Shandong (CN); Xin ZHANG, Shandong (CN); Youliang TIAN, Shandong (CN); Ke YAN, Shandong (CN); Wei LI, Shandong (CN)

(21) Appl. No.: 19/338,906

(22) Filed: Sep. 24, 2025

Related U.S. Application Data
(63) Continuation of application No. PCT/CN2024/110110, filed on Aug. 6, 2024.

(30) Foreign Application Priority Data
Aug. 15, 2023 (CN) 202311026973.8
Dec. 8, 2023 (CN) 202311686660.5

(51) Int. Cl. H04N 9/31; G02B 27/48; G03B 21/60; G09G 3/00

(52) U.S. Cl. CPC H04N 9/3161; G02B 27/48; G03B 21/60; G09G 3/002; H04N 9/3105; H04N 9/317; H04N 9/3182; G09G 2320/0666

(57) ABSTRACT

A laser projection imaging device, comprising: a light source chip, comprising a drive circuit and light-emitting modules; wherein: a microlens array, located on a light-emitting side of the light source chip, and configured to homogenize light spots of the light-emitting modules; and an imaging lens, located on a side of the microlens array facing away from the light source chip along a light beam propagation direction, and configured to receive light beams after passing through the microlens array and project the light beams into an image.

### CROSS-REFERENCE TO RELATED APPLICATIONS

The present application a continuation application of PCT/CN2024/110110 filed on Aug. 6, 2024, which claims priority to the Chinese applications No. 202311026973.8, filed on Aug. 15, 2023, and No. 202311686660.5, filed on Dec. 8, 2023, the entire contents of which are incorporated by reference herein.

### TECHNICAL FIELD

The embodiments of the present application relate to the field of projection imaging technology, and more particularly to a laser projection imaging device.

### BACKGROUND

Compared with LED (Light-emitting Diode) light sources and blue laser excited phosphor light sources in traditional projection TVs (televisions), laser light sources are very efficient light sources that can make up for the low electro-optical efficiency of LED light sources, and low conversion efficiency, poor heat dissipation characteristics, and difficulty in applying to large-size projections of blue laser excited phosphors. The laser display technology corresponding to the laser light sources has the advantages of good monochromaticity, wide color gamut, long life, high brightness, and low power consumption, and is therefore widely used.

The laser light sources widely distributed in the current market are mostly edge emitting lasers (EEL), which require a spatial light modulator called digital micro-mirror devices (DMD) during use. The characteristics of DMD will cause the problem of reduced utilization of the laser light source beam. Due to its characteristics, EEL also has the problem of low beam utilization of the overall optical path structure and the use of other devices to reduce speckle, resulting in a larger overall optical path structure.

### SUMMARY

The embodiment of the present application provides a laser projection imaging device, including: the light-emitting module includes a plurality of light-emitting units made of vertical-cavity surface-emitting lasers, and the light-emitting units include a first light-emitting unit for emitting red laser light, a second light-emitting unit for emitting green laser light, and a third light-emitting unit for emitting blue laser light; and the drive circuit is electrically connected to the light-emitting units and is configured to: receive a driving signal for displaying an image; where the driving signal includes a target operating current representing display brightness of a video signal, a target adjusted pulse width representing display grayscale of the video signal, and light-emitting modules corresponding to the video signal; and drive the light-emitting modules corresponding to the video signal according to the target operating current and the adjusted pulse width, to cause that the light source chip emits laser light to form a target image; a microlens array, located on a light-emitting side of the light source chip, and configured to homogenize light spots of the light-emitting modules; and an imaging lens, located on a side of the microlens array facing away from the light source chip along a light beam propagation direction, and configured to receive light beams after passing through the microlens array and project the light beams into an image.

In the laser projection imaging device provided by the embodiment of the present application, the light-emitting unit made of the vertical-cavity surface-emitting laser (VCSEL) is used as the laser light source, and there is no need to set up a DMD, which improves the utilization rate of the laser light beam, and the cost of the VCSEL is low, thereby reducing the overall cost of the laser projection imaging device. Compared with the traditional EEL, the light beam emitted by the light-emitting unit made of the VCSEL is a circularly symmetrical Gaussian light beam, with high beam quality, small divergence angle, easy beam shaping, and high coupling efficiency. The lateral size of the light beam can reach several to tens of microns, and the size is small, which is easy to manufacture a large-sized high-density monolithic integrated light source chip, and the number of arrays can be increased to increase the power output and obtain a larger and brighter projection image. In addition, since the phase relationship between the light-emitting units made of the VCSEL can be not fixed and the coherence is weak, a monolithic light source chip with equal wavelength intervals can be made, which is conducive to reducing the light beam coherence of the device, weakening the speckle, and improving the output quality of the projection image. It is no longer necessary to set up specific other devices to reduce the speckle, thereby reducing the volume of the overall laser projection imaging device. In this way, it is possible to reduce the volume of the laser projection imaging device and reduce the cost under the premise of weakening the speckle and improving the image quality.

### BRIEF DESCRIPTION OF FIGURES

In order to more clearly illustrate the implementation methods in the embodiments of the present application or the related art, the following is a brief introduction to the drawings required for use in the embodiments or the related technology descriptions. Obviously, the drawings described below are some embodiments of the present application, and a person skilled in the art can also obtain other drawings based on these drawings.

FIG. 1 is a schematic diagram of imaging of a conventional laser projection imaging device according to an embodiment of the present application.

FIG. 2 is a schematic diagram of a three-color laser display optical path structure according to an embodiment of the present application.

FIG. 3 is a schematic structural diagram of an edge-emitting laser according to an embodiment of the present application.

FIG. 4 is a schematic structural diagram of a laser projection imaging device according to an embodiment of the present application.

FIG. 5 is a schematic structural diagram of a Vertical-Cavity Surface-Emitting Laser (VCSEL) according to an embodiment of the present application.

FIG. 6 is a schematic structural diagram of a drive circuit and a light-emitting unit according to an embodiment of the present application.

FIG. 7 is another schematic structural diagram of a drive circuit and a light-emitting unit according to an embodiment of the present application.

FIG. 8 is a schematic diagram of a relationship between luminous intensity and target operating current according to an embodiment of the present application.

FIG. 9 is a schematic diagram of a current pulse according to an embodiment of the present application.

FIG. 10 is another schematic diagram of a current pulse according to an embodiment of the present application.

FIG. 11 is a schematic diagram of an arrangement of light-emitting modules according to an embodiment of the present application.

FIG. 12 is another schematic diagram of an arrangement of light-emitting modules according to an embodiment of the present application.

FIG. 13 is another schematic diagram of an arrangement of light-emitting modules according to an embodiment of the present application.

FIG. 14 is a schematic structural diagram of a light source chip according to an embodiment of the present application.

FIG. 15 is another schematic structural diagram of a light source chip according to an embodiment of the present application.

FIG. 16 is another schematic structural diagram of a light source chip according to an embodiment of the present application.

FIG. 17 is a schematic structural diagram of a light source chip according to an embodiment of the present application.

FIG. 18 is a schematic structural diagram of a microlens array according to an embodiment of the present application.

FIG. 19 is a schematic diagram of an application scenario of a microlens array according to an embodiment of the present application.

FIG. 20 is another schematic diagram of an application scenario of a microlens array according to an embodiment of the present application.

FIG. 21 is another schematic diagram of an application scenario of a microlens array according to an embodiment of the present application.

FIG. 22 is a schematic structural diagram of a base substrate according to an embodiment of the present application.

FIG. 23 is a schematic diagram of a connection mode of a computer controller according to an embodiment of the present application.

FIG. 24 is another schematic structural diagram of a laser projection imaging device according to an embodiment of the present application.

FIG. 25 is a schematic structural diagram of a receiving screen according to an embodiment of the present application.

FIG. 26 is a schematic diagram of an application scenario of a laser projection imaging device according to an embodiment of the present application.

FIG. 27 is a top view of a laser chip according to an embodiment of the present application.

FIG. 28 is a side view of a laser chip according to an embodiment of the present application.

FIG. 29 is a partial cross-sectional view of a first laser unit according to an embodiment of the present application.

FIG. 30 is an energy level diagram before and after quantum well intermixing according to an embodiment of the present application.

FIG. 31 is a flow chart of a method for preparing a laser chip according to an embodiment of the present application.

FIG. 32 is a specific flow chart of preparing a dielectric film according to an embodiment of the present application.

FIG. 33 is a schematic structural diagram of a mask according to an embodiment of the present application.

FIG. 34 is another top view of a laser chip according to an embodiment of the present application.

FIG. 35 is another top view of a laser chip according to an embodiment of the present application.

FIG. 36 is another top view of a laser chip according to an embodiment of the present application.

FIG. 37 is another top view of a laser chip according to an embodiment of the present application.

FIG. 38 is a top view of a laser light source according to an embodiment of the present application.

FIG. 39 is a side view of a laser light source according to an embodiment of the present application.

FIG. 40 is another side view of a laser light source according to an embodiment of the present application.

### DETAILED DESCRIPTION

In order to make the purpose and implementation method of the present application clearer, the exemplary implementation method of the present application will be clearly and completely described below in conjunction with the drawings in the exemplary embodiments of the present application. Obviously, the described exemplary embodiments are only part of the embodiments of the present application, rather than all the embodiments.

It should be noted that the brief description of terms in the present application is only for the convenience of understanding the embodiments described below, and is not intended to limit the embodiments of the present application. Unless otherwise specified, these terms should be understood according to their common and usual meanings.

The terms “includes,” “including,” and “having,” and any variations thereof, are intended to cover but not exclude inclusion, for example, a product or device including a list of components is not necessarily limited to all the components expressly listed but may include other components not expressly listed or inherent to such product or device.

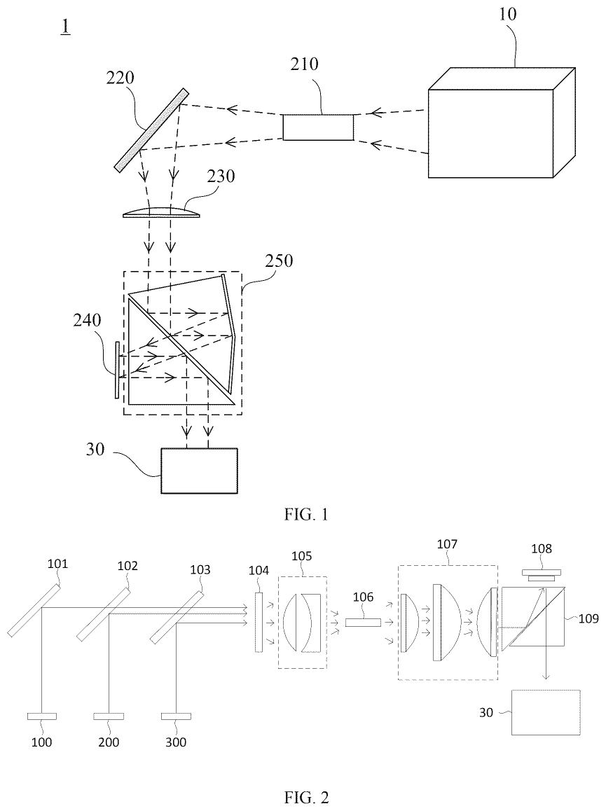

FIG. 1 is a schematic diagram of imaging of a conventional laser projection imaging device commonly found in the market, which is mainly composed of a light source 10, a light modulation assembly 20, and a lens assembly 30. As shown in FIG. 1, the illumination light beam emitted by the light source 10 enters the light modulation assembly 20. The light source 10 includes a laser component, which can emit blue laser light, and the light source also includes a wavelength conversion device, which is used to receive the blue laser light to generate other primary colors except blue, which are used together to form the illumination light beam.

The light modulation assembly 20 includes a first light homogenizing portion 210, a reflector 220, a lens 230, a light valve 240, and a prism component 250. The light valve 240 is configured to modulate the illumination light beam incident therein into a projection light beam according to a driving signal for displaying an image, and emit the projection light beam toward the lens assembly 30. The first light homogenizing portion 210 is a light pipe, and can also be a fly-eye lens.

The light valve 240 is a light modulation device, and is shown as a reflective light valve in the figure. The light valve 240 includes a plurality of reflective mirrors, each of which corresponds to a pixel in the projection image. Exemplarily, according to the to-be-displayed projection image, the reflective mirror corresponding to the pixel to be in a bright state for displaying among the plurality of reflective mirror of the light valve 240 can reflect the light beam to the lens assembly 30, and the light beam reflected to the lens assembly 30 is called the projection light beam. In this way, the light valve 240 can modulate the illumination light beam to obtain the projection light beam, and realize the display of the image through the projection light beam.

The light valve 240 in the conventional laser projection imaging device is mostly a digital micro-mirror device (DMD). The digital micro-mirror device includes a plurality of (e.g., tens of thousands of) tiny reflective mirrors that can be driven and rotated individually. The plurality of tiny reflective mirrors can be arranged in an array. One tiny reflective lens (e.g., each tiny reflective lens) corresponds to one pixel in the to-be-displayed projection image.

In the optical path architecture provided in FIG. 1, the light source 10 and the light valve 240 are respectively driven and controlled by the display control component. The light source receives the brightness dimming signal and the timing lighting control signal corresponding to the driving signal to emit light, and the light valve, e.g., DMD, receives the driving control signal corresponding to the driving signal, and flips the thousands of tiny mirrors on its surface at a positive angle or a negative angle corresponding to the driving signal, and forms the light beam from the light source irradiating its surface into an image to be projected and displayed, and reflects it into the lens.

Next, based on FIG. 2, the three-color laser display optical path structure in the conventional laser projection imaging device shown in FIG. 1 is explained. As shown in FIG. 2, in the conventional three-color laser display scheme, the laser light source of the laser display uses a multi-chip three-color laser to emit a green laser light beam 100, a blue laser light beam 200, and a red laser light beam 300. The green laser light beam 100 is reflected by the green light reflective mirror 101 and projected by the blue dichroic sheet 102 and the red dichroic sheet 103. The blue laser light beam 200 is reflected by the blue dichroic sheet 102 and projected by the red dichroic sheet 103. After the red laser light beam 300 is reflected by the red dichroic sheet 103, the laser light beam reaches the diffusion sheet 104, and after being homogenized by the diffusion sheet 104, it reaches the first lens group 105, and after being converged by the first lens group 105, it enters the light pipe 106. After passing through the light pipe 106, the laser light beam reaches the second lens group 107. After being reflected and refracted by the multiple second lens groups 107, the laser light beam enters the TIR (Total Internal Reflection) prism. The laser light beam is totally reflected by the TIR prism 108, converged and focused to the surface of the DMD 109, and the laser light beam reflected by the DMD 109 directly penetrates the TIR prism 108 and enters the lens assembly 30, and then is magnified by the lens assembly 30 and formed on the screen.

In this structure, DMD 109, as a spatial light modulator, is the main display element of the digital light processing (DLP) display technology. It is generally composed of thousands of micro-high-reflection aluminum micro-mirror arrays made of semiconductor technology. Each reflective micro-mirror corresponds to a pixel point. Under the control of digital signals, it realizes a ±12° deflection to reflect the incident laser light beam to the lens assembly 30. The laser light beam that does not enter the lens assembly 30 is absorbed, resulting in a decrease in the utilization rate of the laser light beam. The DMD 109 is monopolized by certain technology manufacturers and is expensive. Since the TIR prism 108 is very close to DMD 109 in position, it is easy to generate discrete light and affect the image contrast. Furthermore, the structure needs to adopt an optical addressing method for projection imaging. The process of optical addressing is mainly to first convert the optical signal into spatial charge distribution, refractive index distribution, etc., through a spatial light modulator (SLM), such as the DMD mentioned above, and then modulate through various effects (electro-optical effect, birefringence effect, etc.) to read out the optical signal, and the corresponding structure can be, e.g, a liquid crystal light valve, a cathode ray tube liquid crystal light valve, etc. The requirement to set up devices such as the spatial light modulator leads to a complex overall structure and a large volume of the laser display optical path structure, which is not conducive to miniaturization design.

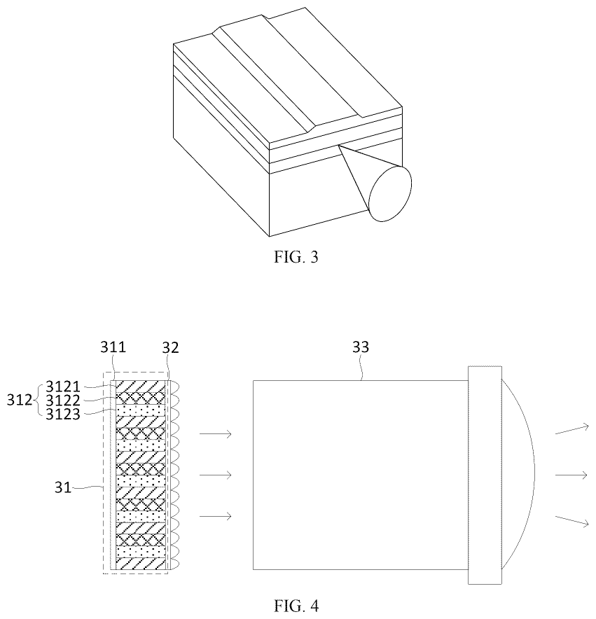

FIG. 3 is a schematic structural diagram of an edge-emitting laser according to an embodiment of the present application. In conventional laser projection imaging devices, edge-emitting lasers are often used to provide light sources. The conical diagram shown in FIG. 3 represents a laser light beam. The laser light source of the edge-emitting laser is firstly EEL. Due to the good monochromaticity of lasers, their coherence is strong. The laser light beam is highly coherent in time and space due to the scattering of the rough surfaces of the optical elements in the laser display optical path structure and the influence of the subtle irregularities of the display screen surface, and a large number of interference fringes and speckle noise will be generated, which will seriously affect the image quality and the viewer experience.

In order to reduce the influence of speckle, a rotating diffusion sheet or a diffusion wheel device (such as diffusion sheet 104) is usually added to the optical path system in the related art. However, the addition of the rotating diffusion sheet or the diffusion wheel device and other light diffusion structures will reduce the utilization rate of light energy, resulting in poor display effects. Meanwhile, it will increase the overall system volume of the optical path structure, which is not conducive to miniaturization design. In addition, the light spot corresponding to the light beam emitted by the EEL is elliptical. Since the elliptical light needs to be shaped into a circular Gaussian light spot, it is also necessary to set a corresponding optical element for beam shaping. The setting of the optical elements will also make the overall structure of the optical path system complex and increase the volume, which is not conducive to miniaturization design.

Based on the above problems, an embodiment of the present application provides a laser projection imaging device. FIG. 4 is a schematic structural diagram of a laser projection imaging device according to an embodiment of the present application. As shown in FIG. 4, the present application adopts a micro semiconductor laser panel (e.g., Micro Laser Diode Panel, MLDP) technology, and uses a light source chip 31 as a laser light source of the laser projection imaging device. Meanwhile, a microlens array 32 is arranged on the light-emitting side of the light source chip 31 to homogenize light spots of light-emitting modules of the light source chip 31, and an imaging lens 33 is arranged on a side of the microlens array 32 away from the light source chip 31 to receive the light beams after passing through the microlens array 32 and project them for imaging.

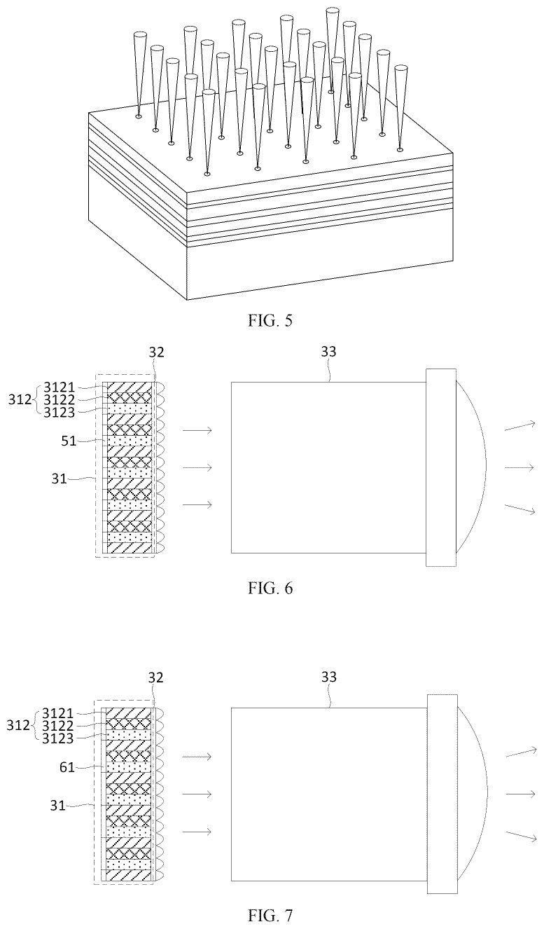

FIG. 5 is a schematic diagram of a VCSEL structure according to an embodiment of the present application, and the conical diagram in FIG. 5 represents the laser light beam. Compared with the conventional EEL that provides a light source, the outgoing light beam of the VCSEL is a circularly symmetrical Gaussian light beam, with a small light beam divergence angle, good beam quality, easy beam shaping, and high coupling efficiency. The lateral size of the outgoing light beam can reach several to tens of microns, which is small in size and easy to manufacture large-sized high-density monolithic integrated two-dimensional light source chips, and the number of chip arrays can be increased, which can improve the power output and obtain a larger and brighter projection image. In addition, for the integrated chip, an active region has a small volume, a low operating threshold and energy consumption, which can effectively improve the electro-optical conversion efficiency. Moreover, the phase relationship between the light-emitting units in the light source chip may not be fixed, the coherence is weak, and a monolithic light source chip with equal wavelength intervals can be made, which is conducive to reducing the light beam coherence of the device, weakening the speckle, and improving the output quality of the projection image. It is no longer necessary to set up specific other devices to reduce the speckle, thereby reducing the volume of the overall laser projection imaging device.

Taking a 0.47-inch DMD as an example, it may have 2.07 million micro-mirrors, which can project 1920*1080 pixels, and the size of each light-emitting module 312 is 5.4 μm. The size of the light-emitting unit made of VCSEL can be reduced to less than 5 μm. It can be seen that using VCSEL as the light-emitting unit of the micro laser diode panel array can achieve higher resolution and further reduce the volume of the overall optical path system. By comparing with related solutions, in the embodiment of the present application, the use of multiple lens groups can reduced, the volume of the optical path can be greatly compressed, and the utilization rate of light energy can be improved. Since the light source chip 31 integrates R, G, and B three-color light sources, it avoids the pixel alignment problem caused by multiple micro laser diode panel arrays and can simplify the system structure.

Continuing to refer to FIG. 4, the light source chip 31 may include a drive circuit 311 and light-emitting modules 312.

The light-emitting module 312 includes a plurality of light-emitting units made of VCSEL, and the light-emitting units include a first light-emitting unit 3121, a second light-emitting unit 3122 and a third light-emitting unit 3123; the first light-emitting unit 3121 emits red laser light, the second light-emitting unit 3122 emits green laser light, and the third light-emitting unit 3123 emits blue laser light.

The drive circuit 311 is electrically connected to the first light-emitting unit 3121, the second light-emitting unit 3122, and the third light-emitting unit 3123, and is configured to: receive a driving signal for displaying an image; and drive the light-emitting modules corresponding to the video signal with the target operating current and a target adjusted pulse width, to cause that the light source chip emits a target image. The driving signal includes a target operating current representing display brightness of a video signal, the target adjusted pulse width representing display grayscale of the video signal, and light-emitting modules corresponding to the video signal.

In some embodiments, the light-emitting unit can be driven by an electrical addressing method. In the electrical addressing method, a video signal or a computer level signal is usually used to control the complex transmittance of the spatial light modulator. The signal is loaded onto the corresponding light-emitting unit by scanning through the electrode on the spatial light modulator. In the embodiment of the present application, the light-emitting unit is driven by an electrical addressing method, and the light-emitting unit can be controlled to emit light of a target color and target brightness, so that the light source chip 31 as a whole can emit light to form the target image, thereby saving the corresponding devices for optical addressing modulation, which is beneficial to reducing the overall volume and facilitating miniaturization design.

In some embodiments, the drive circuit 311 may be a CMOS drive circuit 311. The drive circuit 311 may drive a specific light-emitting unit to emit light based on electrical addressing. For example, the light source chip 31 may include multiple light-emitting modules 312. For each light-emitting module 312, the color, brightness, time, etc., displayed by the light-emitting module 312 are controlled based on the image to be displayed. A specific light-emitting unit in each light-emitting module 312 may be controlled to emit color light with a specific brightness and a specific time. For example, the first light-emitting unit 3121 in a certain light-emitting module 312 may be controlled to emit red laser light with a specific brightness and a specific duration, and the second light-emitting unit 3122 and the third light-emitting unit 3123 in the light-emitting module 312 may be controlled not to emit light. After the laser light beams emitted by the light-emitting module 312 passes through the microlens array 32, the laser light beams, i.e., light spots, may be homogenized. The homogenized light spots pass through the imaging lens 33. The imaging lens 33 may project an image based on the received light spots, for example, projecting the projected light onto the receiving screen 2401, and the user may view the corresponding image. In the present application, the CMOS drive circuit 311 is utilized to control and form an imaging image at the light source, and projects it onto the screen through the imaging lens 33, which is conducive to miniaturized system integration and can reduce costs and other advantages.

FIG. 6 is a schematic diagram of a drive circuit and a light-emitting unit structure according to an embodiment of the present application. As shown in FIG. 6, the number of drive circuits 311 for a single light-emitting module 312 can be multiple, for example, the number of drive circuits 311 can be equal to the number of light-emitting units in the light-emitting module 312. Each drive circuit 311 is electrically connected to one light-emitting unit, and controls the light-emitting unit. For example, FIG. 6 illustrates the drive circuit as a first drive circuit 51. In this way, the first drive circuits 51 can be arranged in an array-like manner with the light-emitting units in the light-emitting module 312, and when controlling the light-emitting unit to emit a specific color laser light, each first drive circuit 51 only controls one light-emitting unit to emit light. Thus, one light-emitting unit can be controlled by each drive circuit 311, making the control of the light-emitting unit more flexible.

FIG. 7 is another schematic diagram of a drive circuit and light-emitting unit structure according to an embodiment of the present application. As shown in FIG. 7, the drive circuit 311 can realize multi-channel output. In FIG. 7, the drive circuit is schematically shown as second drive circuits 61, and the second drive circuits 61 can be set in a one-to-one correspondence with the light-emitting modules 312. The output terminals of a single second drive circuit 61 are respectively connected to the first light-emitting unit 3121, the second light-emitting unit 3122, and the third light-emitting unit 3123 corresponding to the same light-emitting module 312. In this way, the number of first drive circuits 51 can also be multiple, and can also be arranged in an array, and can have an arrangement similar to the array arrangement of the light-emitting module 312, so as to facilitate the electrical connection between the drive circuits and the light-emitting units in the corresponding light-emitting module, and simplify the circuit connection structure. In the embodiment of the present application, a single second drive circuit 61 can control the light emission of multiple light-emitting units in the light-emitting module 312, thereby reducing the number of drive circuits 311.

In some embodiments, in order to make the light-emitting unit emit light with a specific brightness and a specific color, the drive circuit 311 can apply a target operating current and/or a target adjusted pulse width to the corresponding light-emitting unit(s); and the target operating current can be used to control the brightness of the light-emitting unit, and the target adjusted pulse width can be used to control the grayscale of the light-emitting unit.

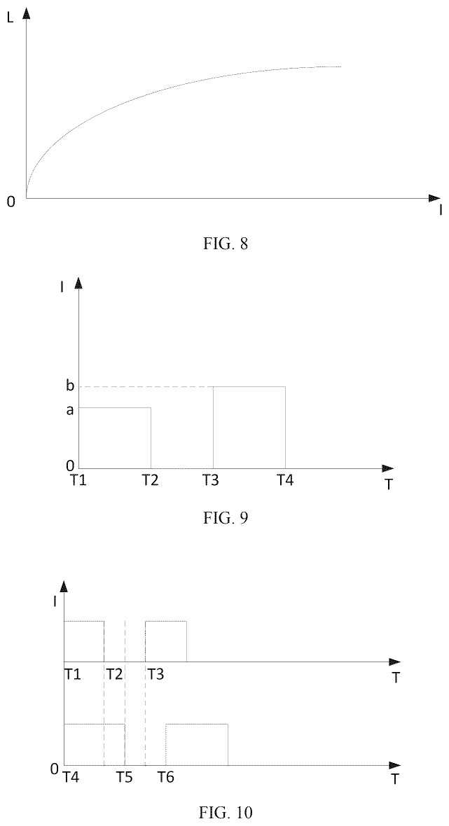

Within the operating range of the light source chip, the relationship between its luminous intensity and the target operating current can be represented by an L-I curve. FIG. 8 is a schematic diagram of a relationship curve between luminous intensity and target operating current according to an embodiment of the present application, where the horizontal axis I represents the current intensity and the vertical axis L represents the luminous intensity. Referring to FIG. 8, as the injected current increases, the luminous intensity also increases. When the luminous intensity tends to saturation, the luminous intensity will no longer increase significantly with the increase of the injected current. The modulation characteristics of the light source chip can be achieved by applying different currents and different pulse widths to the light-emitting unit. The brightness of the light-emitting unit can be changed by adjusting the target operating current and driving time, thereby correspondingly presenting light and dark images of different brightness.

FIG. 9 is a schematic diagram of a current pulse according to an embodiment of the present application, where the horizontal axis represents time and the vertical axis represents current. For example, the current intensity in the T1-T2 time period is a, the current intensity in the T3-T4 time period is b, and a<b. When a certain light-emitting unit is controlled in this current pulse manner, the brightness of the light-emitting unit in the time period corresponding to T1-T2 is less than the brightness of the light-emitting unit in the time period corresponding to T3-T4. In this embodiment, only the same one light-emitting unit is illustrated. The same is true for different light-emitting units. For example, current pulses of different current intensities can be input to different light-emitting units in the same one time period, thereby making the brightnesses of different light-emitting units different. The pulse width can be divided into multiple levels, and different levels represent different grayscale information. By controlling the exposure duty cycle of the pixel(s) in each light-emitting unit, the light-emitting units can have different grayscale levels to achieve a modulation effect on the image grayscale.

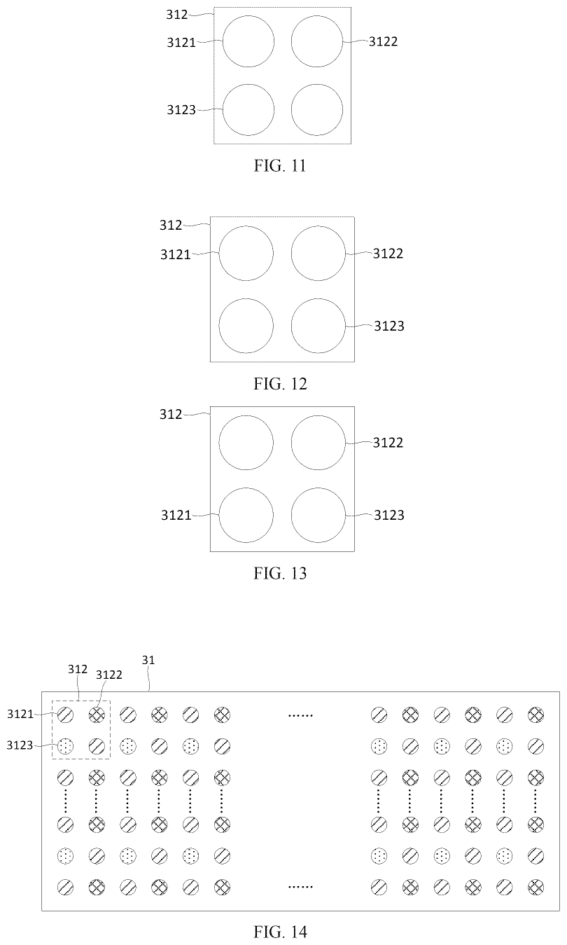

FIG. 10 is another schematic diagram of current pulse according to an embodiment of the present application, where the horizontal axis represents time and the vertical axis represents current. The exposure duty cycle may be calculated as D=P/N, where D represents the exposure duty cycle, P represents the duration of non-zero current intensity in one or more time cycles, N represents the duration of zero current intensity in one or more time cycles, and P+N=100. The relationship between grayscale and exposure duty cycle may satisfy G=P/(P+N)×100%, where G represents grayscale, and further P/N=G/(1−G). For example, the duration of the time period corresponding to T1-T2 is t1, the duration of the time period corresponding to T2-T3 is t2, the duration of the time period corresponding to T4-T5 is t3, and the duration of the time period corresponding to T5-T6 is t4, and t1>t3, (t1÷t2)≠(t3÷t4), that is, the current pulse widths are different, and the exposure duty cycles are also different. When a certain light-emitting unit is controlled in this current pulse manner, the grayscale in the time period corresponding to T1-T3 is different from the grayscale and brightness in the time period corresponding to T4-T6. For example, when a pure white image is displayed, the exposure duty cycle in one or more time cycles can be 100/0. On the contrary, when a pure black image is displayed, the exposure duty cycle in one or more time cycles can be 0/100.

In some embodiments, the image displayed by the light-emitting modules 312 are composed of three primary colors: red R, green G, and blue B. In one image frame cycle, in order to achieve the white balance point, the display time duration of the three primary colors RGB have their own percentages, and the sum of the proportions of the three primary colors is 100%. The grayscale of each light-emitting module 312 can be the sum of the percentages of the three primary colors RGB, that is, G=TR×GR+TG×GG+TB×GB, where TR represents the percentage of the red light display cycle in order to meet the white balance in one frame of image, TG represents the percentage of the green light display cycle in order to meet the white balance in one frame of image, TB represents the percentage of the blue light display cycle in order to meet the white balance in one frame of image, GR represents the grayscale of red, GG represents the grayscale of green, and GB represents the grayscale of blue. In order to achieve a certain white balance requirement, in one frame of image, the red, green, and blue cycle proportions can meet the requirements of 50% for red, 20% for green, and 30% for blue.

In some embodiments, each light-emitting module 312 can be arranged by a 2×2 light-emitting unit array. In some implementations, the light-emitting efficiencies of light-emitting units of different colors are different. In order to achieve an ideal brightness effect, color saturation, and color uniformity, etc., each light-emitting module 312 can be composed of two light-emitting units of the same color and two light-emitting units of different colors. Any light-emitting module may include two first light-emitting units, one second light-emitting unit, and one third light-emitting unit; or, one first light-emitting unit, two second light-emitting units, and one third light-emitting unit; or, one first light-emitting unit, one second light-emitting unit, and two third light-emitting units.

FIG. 11 is a schematic diagram of an arrangement of a light-emitting module 312 according to an embodiment of the present application, FIG. 12 is another schematic diagram of an arrangement of a light-emitting module 312 according to an embodiment of the present application, and FIG. 13 is another schematic diagram of an arrangement of a light-emitting module 312 according to an embodiment of the present application. Referring to FIGS. 11 and 12, each light-emitting module 312 may include a first light-emitting unit 3121, a second light-emitting unit 3122, and a third light-emitting unit 3123. In FIG. 11, the number of the first light-emitting units 3121 is two, and they are arranged in a diagonal manner; and the number of the second light-emitting unit 3122 and the number of the third light-emitting unit 3123 are one, and the second light-emitting unit 3122 and the third light-emitting unit 3123 are also arranged in a diagonal manner. For another example, the number of the second light-emitting units 3122 in FIG. 12 is two, and they are arranged in a diagonal manner; and the number of the first light-emitting unit 3121 and the number of the third light-emitting unit 3123 are one, and the first light-emitting unit 3121 and the third light-emitting unit 3123 are also arranged in a diagonal manner. For another example, the number of the third light-emitting unit 3123 in FIG. 13 is two, and they are arranged in a diagonal manner; and the number of the first light-emitting unit 3121 and the number of the second light-emitting unit 3122 are one, and the first light-emitting unit 3121 and the second light-emitting unit 3122 are also arranged in a diagonal manner. Thus, different light-emitting unit settings can be set based on different requirements to obtain brightness, color saturation, and color uniformity that meet the target projection display requirements.

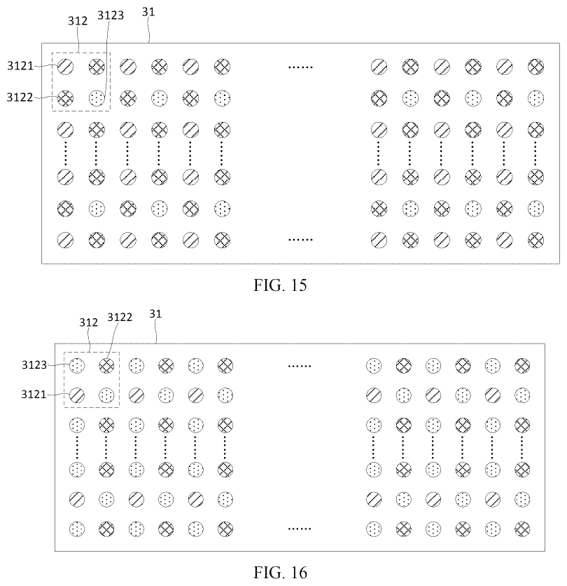

In some embodiments, the light source chip 31 may include a plurality of light-emitting modules 312, and each light-emitting module 312 may include a plurality of light-emitting units. FIG. 14 is a schematic structural diagram of a light source chip 31 according to an embodiment of the present application, FIG. 15 is another schematic structural diagram of a light source chip 31 according to an embodiment of the present application, and FIG. 16 is another schematic structural diagram of a light source chip 31 according to an embodiment of the present application. Referring to FIG. 14, FIG. 14 exemplarily shows a light source chip 31 composed of the light-emitting modules 312 in FIG. 11 above, FIG. 15 exemplarily shows a light source chip 31 composed of the light-emitting modules 312 in FIG. 12 above, and FIG. 16 exemplarily shows a light source chip 31 composed of the light-emitting modules 312 in FIG. 13 above. In FIGS. 14 to 16, the light-emitting units in the light-emitting modules are arranged in an array along the first direction and the second direction, and the colors of the laser light emitted by two adjacent light-emitting units are different along the first direction and/or the second direction.

It should be noted that FIGS. 14 to 16 only illustrate the situation where the colors of the laser light emitted by two adjacent light-emitting units in the first direction and the second direction are different, but it is obvious that in the first direction or the second direction, there may be a situation where the colors of laser light emitted by two adjacent light-emitting units are the same, which is not illustrated here. Among them, the first direction and the second direction can be simply understood as the horizontal direction and the vertical direction, that is, the first direction and the second direction can be perpendicular to each other, and a rectangular matrix is formed by every four light-emitting units. It should be understood that this is only an exemplary description, and it does not limit the first direction and the second direction to be perpendicular to each other. For example, in some possible embodiments, the first direction and the second direction may only intersect, but not be perpendicular to each other, and every four light-emitting units cannot form a rectangular matrix, e.g., can form a parallelogram matrix, etc.

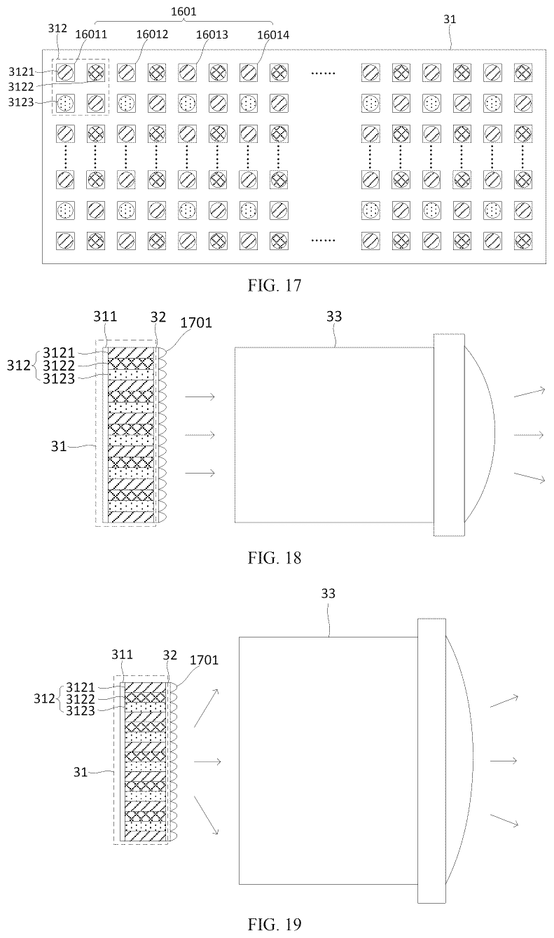

FIG. 17 is a schematic diagram of a light source chip structure according to an embodiment of the present application. In some embodiments, the first light-emitting unit 3121 may include a first light-emitting chip 1601 based on a gallium arsenide substrate, and the laser light wavelength of the first light-emitting chip 1601 is within 630 nanometers to 650 nanometers; the laser light wavelengths of different first light-emitting chips 1601 are arranged at equal intervals; the second light-emitting unit 3122 may include a second light-emitting chip 1602 based on a gallium nitride substrate, and the laser light wavelength of the second light-emitting chip 1602 is within 515 nanometers to 540 nanometers; the laser light wavelengths of different second light-emitting chips 1602 are arranged at equal intervals; the third light-emitting unit 3123 may include a third light-emitting chip 1603 based on a gallium nitride substrate, and the laser light wavelength of the third light-emitting chip 1603 is within 440 nanometers to 480 nanometers; and the laser light wavelengths of different third light-emitting chips 1603 are arranged at equal intervals.

Taking the first light-emitting unit 3121 as an example, the four first light-emitting units 3121 illustrated in FIG. 17 each include a first light-emitting chip 1601. The first light-emitting chips 1601 may be 16011, 16012, 16013 and 16014, respectively. The wavelength of the red laser light emitted by 16011 may be 630 nm (nanometers), the wavelength of the red laser light emitted by 16012 may be 635 nm, the wavelength of the red laser light emitted by 16013 may be 640 nm, and the wavelength of the red laser light emitted by 16014 may be 645 nm. That is, the wavelengths of the laser light emitted by different first light-emitting chips 1601 are arranged at equal intervals. This arrangement can reduce the coherence of the laser light beams emitted by different light-emitting chips, weaken the speckle, and improve the final image quality.

In some embodiments, an interval between the wavelengths of the laser light emitted by different light-emitting chips can be between 3-5 nm. In some embodiments, the light source chip 31 may include multiple light-emitting chips (here, light-emitting chips of the same type, such as the first light-emitting chip 1601), and different equal-interval arrangements may be set. For example, for the first light-emitting chips 1601 arranged in an array, the arrangement of the wavelengths of the emitted laser light along the first direction may be 630 nm, 635 nm, 640 nm, 645 nm, 640 nm, 635 nm, 630 nm, 635 nm, 640 nm, or 630 nm, 635 nm, 640 nm, 645 nm, 630 nm, 635 nm, 640 nm, 645 nm, etc. Continuing to refer to FIG. 4, the laser projection imaging device in the embodiment of the present application may also include a microlens array 32. The main function of the array of microlenses 1701 has been briefly described in the above embodiment and will not be repeated here.

FIG. 18 is a schematic structural diagram of a microlens array 32 according to an embodiment of the present application. As shown in FIG. 18, the microlens array 32 may include microlenses 1701 arranged in an array, and the microlenses 1701 are arranged in one-to-one correspondence with the light-emitting units. Referring to FIG. 18, there is a preset spacing between the microlens array 32 and the imaging lens 33; the light beams after passing through the microlens array 32 are irradiated on the light receiving surface of the imaging lens 33, and the laser light beams emitted by the light source chip 31 are mainly Gaussian light spots, and the light beam energy is mainly concentrated in the center. In order to improve the image quality, the microlens 1701 needs to adjust the divergence angle of the laser light emitted by the light-emitting unit when homogenizing the laser light beam emitted by the corresponding light-emitting unit, so that the emitted laser light is adapted to the optical extension of the imaging lens, thereby ensuring that the microlens array 32 does not change the distribution of the target image emitted by the light source chip 31.

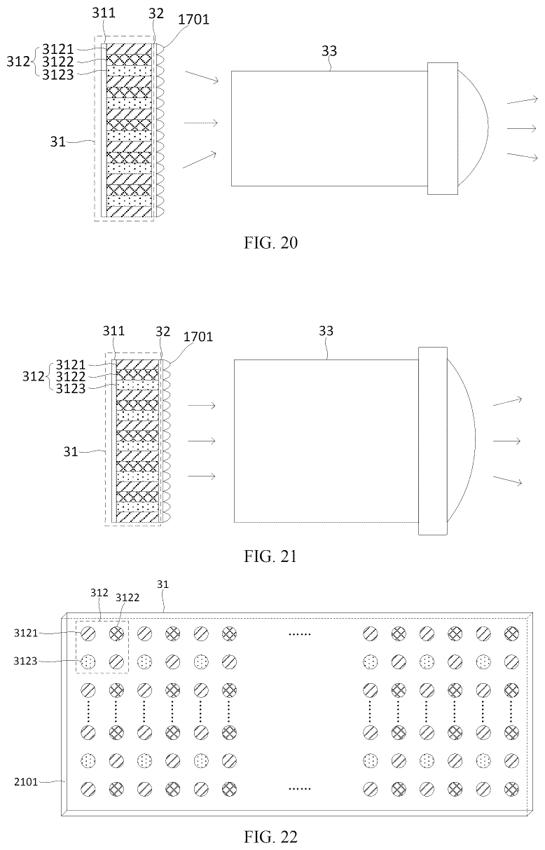

Different imaging lenses have different optical extensions. For different imaging lenses, in the embodiments of the present application, a preset angle range (10° to 12°) for determining whether the light beam of the currently emitted laser light is compatible with the imaging lens. For example, as shown in FIG. 19, if the light beam divergence angle of the laser light emitted by the light-emitting unit is greater than the preset angle range, that is, >12°. The microlens array 32 can contract the light beam divergence angle of the laser light emitted by the light-emitting unit to within the preset angle range. For another example, as shown in FIG. 20, if the light beam divergence angle of the laser light emitted by the light-emitting unit is less than the preset angle range, that is, <10°. The microlens array 32 can expand the light beam divergence angle of the laser light emitted by the light-emitting unit to within the preset angle range. For another example, as shown in FIG. 21, if the light beam divergence angle of the laser light emitted by the light-emitting unit is within the preset angle range, it means that the laser light emitted by the light-emitting unit is compatible with the imaging lens, and there is no need to contract or expand the emitted laser light. In this way, the laser light emitted by the light-emitting unit can be kept as a collimated light beam.

Compared with the EEL collimating lens, the microlens array 32 is easy to be manufactured and has a simple structure. Moreover, since the outgoing light beam of the light source chip 31 is a Gaussian circular spot, the collimation effect is better. Since the red, green, and blue light-emitting units are made of different materials, their light-emitting characteristics are different. Therefore, for different light-emitting units, the surface curvatures and structures of the microlenses 1701 may also be different. However, the microlenses 1701 with different surface curvatures and structures all function to homogenize and shape the light spots into the same size (same imaging screen ratio). The microlens 1701 can be made of one or more materials such as sapphire, glass, or resin, through high-temperature reflow, self-assembly, molding/imprinting/stamping, grayscale mask lithography, or dry etching pattern transfer.

According to the imaging optical theory, if the distance between the light source chip 31 and the imaging lens 33 is large, an image beam contracting element should be used on the side facing the light source chip 31 to make the formed image match the imaging lens 33; otherwise, an image beam expander element should be used. During the design, the preset distance between the light source chip 31 and the imaging lens 33 should be reasonably designed according to the characteristics of the light source chip 31, so as to make the image match the imaging lens 33 as much as possible without using optical elements, thereby avoiding the introduction of optical elements to reduce the utilization rate of light energy.

FIG. 22 is a schematic structural diagram of a base substrate 2101 according to an embodiment of the present application. In some embodiments, the laser projection imaging device may further include a base substrate 2101, and the drive circuit(s) 311 is integrated on one side of the base substrate 2101; and the light-emitting module 312 is located on the side of the drive circuit 311 facing away from the base substrate 2101. Referring to FIG. 21, in the embodiment of the present application, microfabrication (e.g., mass transfer, microtube, etc.) technology may be utilized to integrate the light-emitting modules 312 in the above embodiment onto the same substrate 2101. The material of the base substrate 2101 may be glass, silicon, or sapphire, etc., and a group of electrodes (not shown) may be fabricated on the base substrate by microfabrication technology to realize control of the drive circuit(s) 311. In the present application, the light-emitting units prepared on different epitaxial substrates may be rapidly and accurately transferred to the base substrate 2101 by mass transfer or microtube technology, and form a good electrical connection and mechanical fixation with the drive circuit 311. This method does not need to consider the lattice matching characteristics of the R/G/B epitaxial material and the base substrate 2101, which can greatly improve the stability and reliability of the light-emitting unit, extend the working life, and avoid the problem of affecting the output performance of the light-emitting unit due to the lattice mismatch between the epitaxial material and the base substrate 2101.

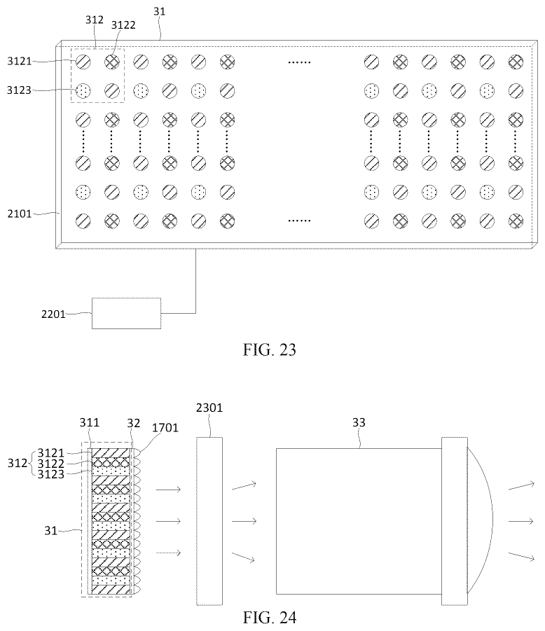

FIG. 23 is a schematic diagram of a connection mode of a computer controller 2201 according to an embodiment of the present application. In some embodiments, in order to control the drive circuit 311 so that the light-emitting unit can emit a laser light beam with parameters such as a specific color and a specific brightness, a computer controller 2201 can also be provided, and the computer controller 2201 can be connected to the drive circuit 311; the drive circuit 311 is not shown in FIG. 22, so it is only shown as being electrically connected to the base substrate 2101, but it should be understood that the drive circuit 311 is provided on the base substrate 2101, and the computer controller 2201 is actually electrically connected to the drive circuit 311. The computer controller 2201 can transmit the driving signal to the drive circuit 311 for the image to be projected.

In some embodiments, there is no fixed phase relationship between the light-emitting units, and the coherence between them is weak, which is conducive to improving speckle. In order to further reduce the speckle, optical elements 2301 can be set between the light source chip 31 and the imaging lenses 33, and the optical elements 2301 are set in one-to-one correspondence with the light-emitting units. The optical element 2301 can be used to reduce imaging speckle. FIG. 24 is another schematic structural diagram of a laser projection imaging device according to an embodiment of the present application, and the optical element 2301 can be at least one of a wave plate, a compound eye, or a diffractive optical element. For example, a wave plate can be set between the light source chip 31 and the imaging lenses, and the phases of the laser light beams are changed by the action of the wave plate to reduce the coherence between different laser light beams, thereby reducing speckle. In some embodiments, the corresponding wave plate can be set according to the polarization states of the laser light beams and the specific wave plate axis direction can be set. Taking linear polarized light as an example, a quarter wave plate or a half wave plate can be set, where the phase delay difference of the quarter wave plate and the half wave plate in the linear polarization direction is π/2 and π respectively, and the corresponding phase propagation distances are λ/4 and λ/2 respectively. In some embodiments, the axial direction of the quarter wave plate or half wave plate can be determined based on actual needs. For example, if the laser light beam is linearly polarized light and needs to remain linearly polarized light after passing through the wave plate, the polarization direction of the linearly polarized light needs to be kept along a certain axis of the quarter wave plate or half wave plate, so that the polarization direction will not change. If the polarization direction of the laser light beam incident on the half wave plate does not coincide with any axis, although the polarized light is still polarized light, the polarization direction rotates. For example, if the angle between the linear polarized light and the axis is 45°, the polarization direction rotates 90°. If the linear polarized light incident on the quarter wave plate is 45° with the axis, the linear polarized light will be converted into circularly polarized light after passing through the quarter wave plate (conversely, the circularly polarized light can obtain linearly polarized light after passing through the quarter wave plate). In some embodiments, the wave plate can be made of quartz crystal (SiO2), which has high transparency and high optical quality in a large wavelength range. In some embodiments, it can also be made of materials such as calcite, magnesium fluoride, sapphire, mica, etc.

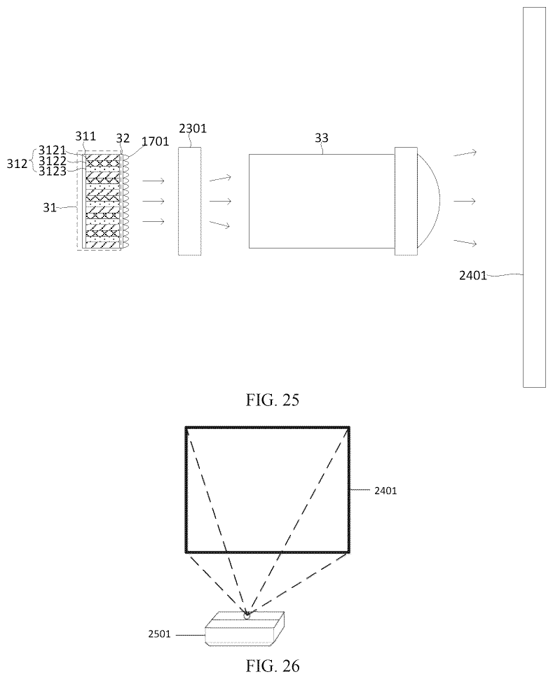

In order to enable the laser projection imaging device provided in the embodiment of the present application to be viewed by the user, the laser projection imaging device provided in the embodiment of the present application may also include a receiving screen 2401. FIG. 25 is a schematic structural diagram of the receiving screen 2401 provided in one or more embodiments of the present application. The receiving screen 2401 may be arranged on the side of the light-emitting from the imaging lens 33. The receiving screen 2401 may receive the light emitted from the imaging lens 33 to present a projection image corresponding to the target image. Exemplarily, the type of the receiving screen 2401 in the embodiment of the present application may be selected based on actual needs. Here, an example is provided. The receiving screen 2401 may be a Fresnel projection screen. In some embodiments, the Fresnel projection screen may be composed of multiple film layers, such as a surface layer, a coloring layer, a diffusion layer, a Fresnel lens layer, and a reflection layer, etc.

The laser projection imaging device in the embodiment of the present application can project light onto the Fresnel projection screen. The light enters the screen through refraction of the surface layer, and reaches the Fresnel lens layer after passing through the coloring layer, diffusion layer, etc., in sequence. A reflective layer is set on the back of the Fresnel lens layer. The light is reflected by the reflective layer and emitted from the screen, and finally received by the human eyes. It should be noted that in some embodiments, the coloring layer, diffusion layer and other film layers may be flexibly set according to certain requirements, that is, the coloring layer, diffusion layer and other film layers may not be a separate film layer, and may also be set in the same layer as other film layers. Therefore, in some embodiments, the order of light passing may be different from this example, but it should be understood that this is only an exemplary description and should not be understood as an improper description.

FIG. 26 is a schematic diagram of an application scenario of a laser projection imaging device according to an embodiment of the present application, in which 2501 represents a forming device composed of the laser projection imaging device except the receiving screen 2401 in the above embodiment. During use, the computer controller 2201 can output a specific control signal to the drive circuit 311 based on the image to be output, and the drive circuit 311 controls the specific light-emitting unit in each light-emitting module 312 to emit a specific laser light beam based on the control signal. The laser light beam can be homogenized, diverged, contracted, collimated, etc., through the microlens array 32. The laser light beam passing through the microlens array 32 enters the imaging lens 33, and the imaging lens 33 can project an image based on the received light spots (i.e., the laser light beams), e.g., project the projection light onto the receiving screen 2401, and the user can watch the corresponding image.

As mentioned above, the laser light sources widely distributed in the current market are mainly edge-emitting lasers. Due to the good monochromaticity of lasers, their coherence is strong. After being scattered by the rough optical surfaces of the projection system and affected by the slight irregularities of the screen surface, the light beam is highly coherent in time and space, generating a large number of interference fringes and speckle noise, which seriously affects the image quality and viewer experience. Moreover, when the laser cavity surface light density reaches the threshold, it absorbs photons and generates heat, causing the band gap here to contract, making it easier to absorb photons, and generating more heat. This repeats, causing “thermal runaway” and eventually burning the laser cavity surface, that is, optical catastrophic damage occurs.

Considering that the generation and severity of speckle in laser projection display are related to multiple links and factors, it can be roughly divided into two processes.
(1) The speckle generated by the laser projection display machine itself is mainly related to the following factors. (A) It is related to the coherence of the laser light source used. The better the coherence, the more severe the speckle. (B) It is related to the surface roughness and aperture size of each element in the optical machine system. The laser light is prone to be scattered when passing through a rough surface. It will also be scattered when it encounters the surface of the element and the floating dust in the air during the propagation process of the laser light. The interference of the scattered sub-waves will produce speckle.
(2) The speckle generated by the display screen is related to the surface condition of the display screen. The speckle generated by the above process or link is generally called primary speckle. The human eyes are equivalent to an optical system, including structures such as the cornea, lens, vitreous body and retina. These structures are also rough for the wavelength of light, so new speckles will be formed on the retina. These speckles are called secondary scattering speckles. Different laser light wavelengths will produce different speckle patterns. When the wavelength increases, the observed speckle pattern will expand in spatial scale, and when the wavelength decreases, the speckle pattern will contract. The degree of scaling of the speckle pattern in spatial scale depends on the change in distance from the point on the observation plane through which the laser light passes after mirror reflection to the speckle pattern. This is because, on the one hand, the diffraction angle is directly proportional to the illumination wavelength, and on the other hand, the change in laser light wavelength will cause a change in random phase shift. The causes and influencing factors of speckle believe that the size of speckle is closely related to multiple factors such as laser light wavelength, light source angle and screen roughness. The relationship between speckle contrast and laser light wavelength and screen clarity is:

$$C ∝ {[ 1 + 8 {{π}^{2} ( \frac{δλ}{\overline{λ}} )}^{2} {( \frac{σ}{\overline{λ}} )}^{2} ]}^{- \frac{1}{4}} .$$

Among them, λ̅ represents the average wavelength of the illumination; δλ represents the wavelength range, and σ represents the standard deviation of the scattering surface (screen). Through this formula analysis, it is determined that the speckle contrast is inversely proportional to the laser spectrum width and the square root of the screen roughness. Different laser light wavelengths will produce independent non-correlated speckle patterns, thereby achieving the purpose of reducing the speckle contrast. By changing the laser light wavelength to produce independent non-correlated speckle patterns, the coherence of the laser light source can be reduced to produce independent non-correlated speckle patterns. Moreover, the larger the spectrum width and the rougher the scattering surface, the smaller the speckle contrast will be.

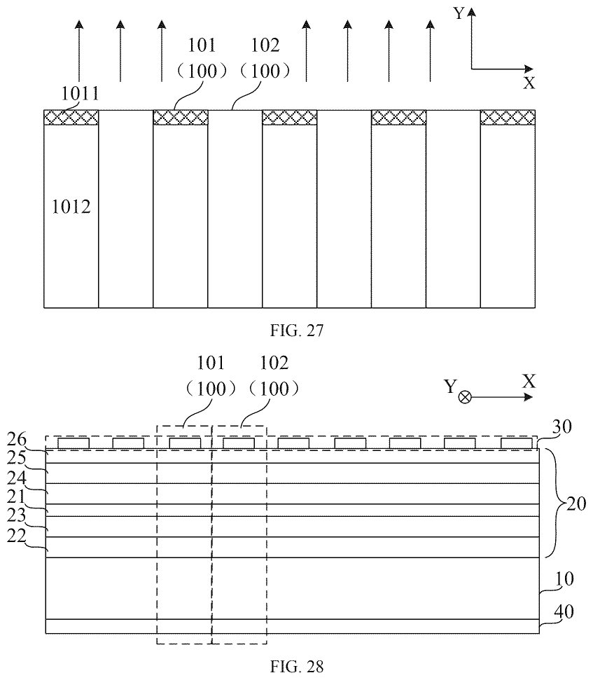

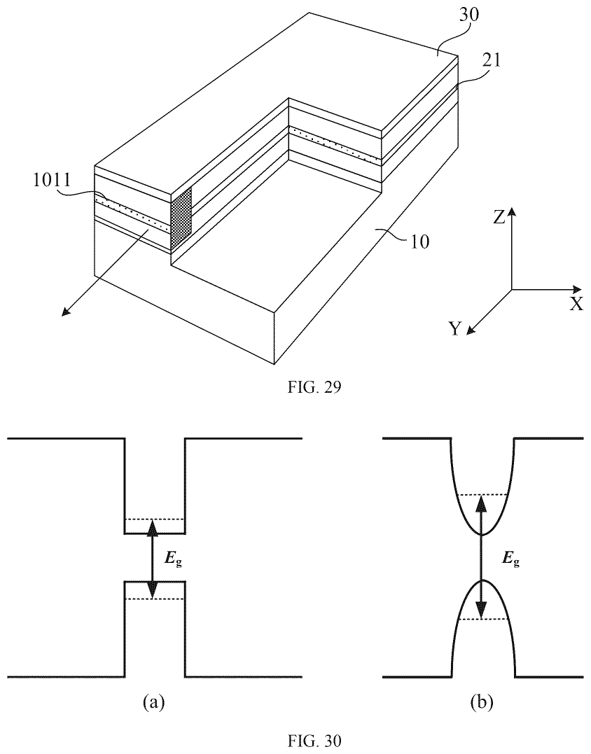

Based on the above analysis, an embodiment of the present application also provides a laser chip. By preparing laser units that emits laser light of different central wavelengths on the laser chip, the coherence of the laser light emitted by the laser chip is deteriorated, the speckle contrast of the projected image is reduced, and the image quality of the image is improved. FIG. 27 is a top view of a laser chip according to an embodiment of the present application; FIG. 28 is a side view of a laser chip according to an embodiment of the present application; and FIG. 29 is a partial cross-sectional view of a first laser unit according to an embodiment of the present application. As shown in FIGS. 27, 28 and 29, the laser chip includes: a semiconductor substrate 10; an epitaxial layer 20, located on a side of the semiconductor substrate 10, the epitaxial layer 20 including an active layer 21, and where the active layer 21 includes a quantum well and a quantum barrier; a first electrode layer 30, located on a side of the epitaxial layer 20 facing away from the semiconductor substrate 10; and a second electrode layer 40, located on a side of the semiconductor substrate 10 facing away from the epitaxial layer 20.

The laser chip includes at least two laser units 100 that emit laser light of the same color and are arranged along a width direction X of the laser chip. The at least two laser units 100 include at least one first laser unit 101 and at least one second laser unit 102. The central wavelengths of the laser light emitted by the first laser unit 101 and the second laser unit 102 are different. The active layer of the first laser unit 101 includes a first non-absorption window 1011 and a non-doped region 1012 that are arranged along a cavity length direction Y. The first non-absorption window 1011 is adjacent to a light-emitting cavity surface of the first laser unit 101. The active layer of the second laser unit 102 is a quantum well hybrid active layer.

It should be noted that it is difficult for each laser unit 100 to emit laser light with only one wavelength, and the laser light emitted by the laser unit 100 contains light of multiple wavelengths in a wavelength range. The central wavelength of the laser light emitted by the laser unit 100 is the median of the multiple wavelengths, or the average of the minimum wavelength and the maximum wavelength of the laser light. If the laser unit 100 emits laser light with a central wavelength of 642 nanometers, then the laser unit 100 may actually emit laser light of different wavelengths in the range of 641 nanometers to 643 nanometers. Laser light with the same central wavelength has strong coherence. There will be certain differences in the colors of laser light with different central wavelengths. In the embodiment of the present application, the laser light of the same color refers to laser light whose wavelengths are within the wavelength range corresponding to the same color. In the related art, the central wavelengths of the laser light of the same color emitted by the laser chips in the same laser are all the same, so the coherence of the laser light of this color is strong, resulting in more serious speckle in the formed projection image. In the embodiment of the present application, a plurality of laser units 100 are prepared on the same laser chip, and the laser light of the same color is divided into light of at least two different central wavelengths. In this way, on the basis of ensuring that the laser light color of each laser unit 100 are the same, the laser light of the same central wavelength is reduced, thereby reducing the coherence of the laser light, and further reducing the speckle contrast of the projected image, thereby improving the image quality of the image. In addition, speckle is related to wavelength, and the longer the wavelength, the larger the speckle. Therefore, red laser light has the greatest impact on speckle. Accordingly, the laser chip can be a red laser chip. In some embodiments, the central wavelength of the laser light emitted by the laser unit in the red laser chip ranges from 625 nm to 650 nm, which can enhance the user's visual experience.

It should also be noted that the figure only uses a laser chip with two different central wavelengths as an implementable solution, but the embodiments of the present application are not limited thereto. In other embodiments, the laser chip can also emit laser light with more than two different central wavelengths. In the above embodiments, the non-doped region 1012 refers to the active layer of the corresponding region that is not doped by the doping material. Accordingly, the central wavelengths of the laser light emitted by the first laser units 101 are the same. The active layer of the second laser unit 102 is a quantum well hybrid active layer, that is, the active layer of the second laser unit 102 is doped using the quantum well hybrid technology. When the doping material is the same, the blue shifts of the central wavelengths are different when the doping concentrations are different. Therefore, by controlling the doping concentration of different second laser units 102, the central wavelengths of the laser light emitted by different second laser units 102 are also different. In this way, the laser chip can emit laser light with more than two different central wavelengths. It can be understood that quantum well hybridization is a process in which atoms from quantum wells and their corresponding quantum barriers diffuse with each other, thereby changing the quantized energy state. See FIG. 30, where (a) is the energy level diagram before quantum well intermixing, and (b) is the energy level diagram after quantum well intermixing. By comparison, it can be seen that after quantum well intermixing, the forbidden band width is significantly widened, where the forbidden band width refers to the energy difference between the lowest energy level of the conduction band and the highest energy level of the valence band (i.e., the minimum value of the energy difference between the conduction band and the valence band) Eg. See the following photon energy formula:

$$λ \approx \frac{1.24}{{E}_{g}} .$$

According to the formula, when the forbidden band width increases, the central wavelength of the laser light decreases, that is, the central wavelength blue shifts, so the change of the central wavelength of the laser light can be achieved through quantum well hybridization technology. Meanwhile, this method can avoid multiple epitaxial growth of the epitaxial layer, the process complexity is low, and it can greatly reduce the cost and preparation time. In addition, quantum well hybridization technology can accurately control the blue shift of the central wavelength of the laser light, so that it can prepare a variety of laser chips with different central wavelengths as required.

In addition, the forbidden band width of the active layer material of the second laser unit 102 having the quantum well hybrid active layer increases, thereby increasing the optical catastrophic damage threshold, so that the output power of the second laser unit 102 does not reach the optical catastrophic damage threshold, thereby reducing the occurrence of optical catastrophic damage of the second laser unit 102. Accordingly, the second laser unit 102 can withstand a larger output power. Meanwhile, the band gap of the first laser unit 101 at the first non-absorption window 1011 becomes wider, and the corresponding wavelength becomes shorter and does not match the wavelength of light output by the first laser unit 101, and then the first non-absorption window 1011 will not absorb the light with the wavelength of the first laser unit 101, so that no heat is generated at the light-emitting cavity surface of the first laser unit 101, thereby reducing the occurrence of optical catastrophic damage of the first laser unit 101.

In some embodiments, the material of the quantum well is GaInP, and the material of the quantum barrier is AlGaInP.

In some embodiments, the material of the semiconductor substrate 10 includes silicon, gallium arsenide or gallium nitride. In other embodiments, the material of the semiconductor substrate 10 can also be other semiconductor materials, which is not limited in the present application. For example, the semiconductor substrate 10 can be an N-type gallium arsenide substrate.

In some embodiments, referring to FIG. 28, the epitaxial layer 20 may further include a lower confinement layer 22, a lower waveguide layer 23, an upper waveguide layer 24, an upper confinement layer 25 and an ohmic contact layer 26. In this way, the lower confinement layer 22, the lower waveguide layer 23, the active layer 21, the upper waveguide layer 24, the upper confinement layer 25 and the ohmic contact layer 26 are sequentially stacked. Accordingly, the lower confinement layer 22, the lower waveguide layer 23, the active layer 21, the upper waveguide layer 24, the upper confinement layer 25 and the ohmic contact layer 26 may be sequentially deposited on the semiconductor substrate 10 by metal organic chemical vapor deposition (MOCVD) when preparing the epitaxial layer. Among them, the lower confinement layer 22 and the upper confinement layer 25 are used to improve the carrier confinement capability of the semiconductor laser, thereby improving the utilization rate of the carriers; the lower waveguide layer 23 and the upper waveguide layer 24 are used to reduce the waveguide to expand the light spot and reduce the divergence angle of the light beam in the vertical direction. The materials and thicknesses of the lower confinement layer 22, the lower waveguide layer 23, the active layer 21, the upper waveguide layer 24, the upper confinement layer 25 and the ohmic contact layer 26 may be set according to actual requirements.

In some embodiments, the first electrode layer 30 may be a p-type ohmic contact electrode.

In some embodiments, Ti/Pt/Au may be sputtered on the surface of the ohmic contact layer 26 using a magnetron sputtering device to improve the ohmic contact condition, and then annealed to form a p-type ohmic contact electrode. The second electrode layer 40 may be an n-type contact electrode.

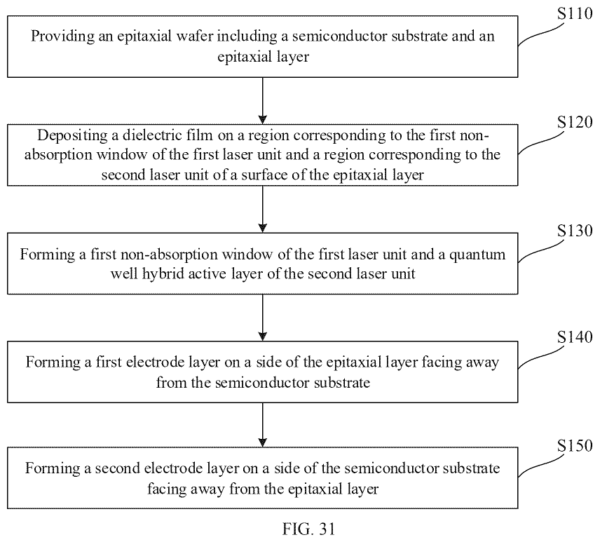

FIG. 31 exemplarily shows a preparation process of the laser chip provided in an embodiment of the present application. As shown in FIG. 31, including the following steps.

S110, an epitaxial wafer including a semiconductor substrate and an epitaxial layer is provided.

In some embodiments, the lasing wavelength of the epitaxial wafer may be 642 nanometers.

S120, a dielectric film is deposited on a region corresponding to the first non-absorption window of the first laser unit and a region corresponding to the second laser unit of a surface of the epitaxial layer.

The laser chip includes at least two laser units that emit laser light of the same color and are arranged along the width direction of the laser chip. The at least two laser units include at least one first laser unit and at least one second laser unit. The central wavelengths of the laser light emitted by the first laser unit and the second laser unit are different.

In this step, the dielectric film is deposited to form a shielding region, so that in the subsequent steps, the forbidden band width of the active layer material corresponding to the non-shielding region changes, while the forbidden band width of the active layer material corresponding to the shielding region remains unchanged, and the lasing wavelength, such as 642 nanometers as mentioned above, of the corresponding laser unit remains unchanged.

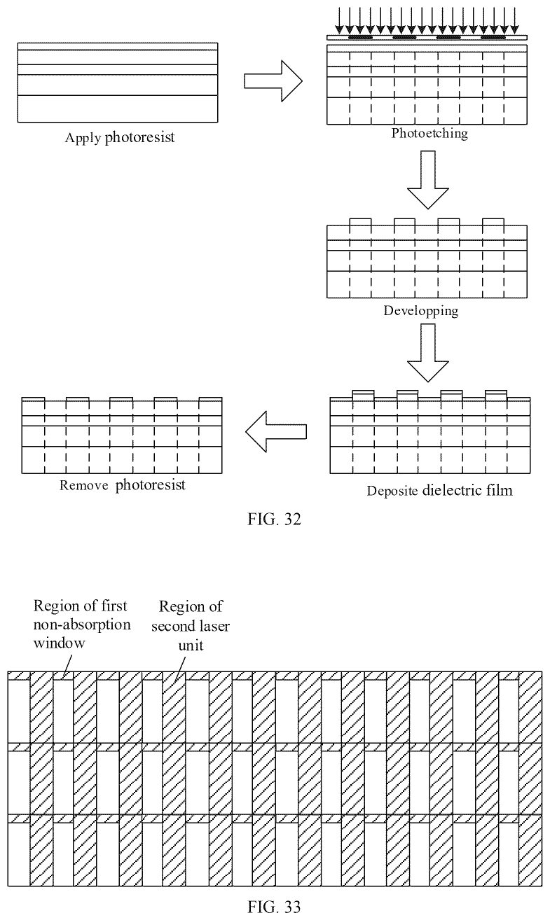

During implementation, reference may be made to FIG. 32. First, a photoresist is applied to the entire surface of the epitaxial layer (a positive photoresist is used in the figure), and the photoresist is exposed by photolithography using the mask shown in FIG. 33 (the mask structure when a negative photoresist is used is complementary to the mask structure in the figure); then, a developer is used to remove the photoresist of the exposed portion, and retain only the photoresist of the non-doped region of the first laser unit; then, a dielectric film (such as SiOx, SixNy, SiOxNy, etc.) is deposited over the entire surface by methods like chemical vapor deposition (CVD) or physical vapor deposition (PVD), with a deposition thickness of 100 to 200 nm; and finally, a photoresist stripping solution or a chemical stripping agent such as acetone is used, the epitaxial wafer with the dielectric film deposited on the entire surface is immersed therein, and it is heated with an ultrasonic cleaner at 60-80° C. for 10-20 min to remove the photoresist and the dielectric film attached to the surface of the photoresist, so as to deposit the dielectric film on the region corresponding to the first non-absorption window of the first laser unit and the region corresponding to the second laser unit of the surface of the epitaxial layer.

S130, a first non-absorption window of the first laser unit and a quantum well hybrid active layer of the second laser unit are formed.

In some embodiments, the product obtained in S120 and the diffusion source Zn₃As₂ or ZnO are placed in a quartz tube, fixed on both sides and evacuated to a high vacuum (<2*10−3 Pa) and then sealed, and placed in a diffusion furnace, annealing furnace or vertical furnace for sintering. By controlling the diffusion temperature of 400 to 650° C. and the diffusion time of 5 to 60 min, the depth of diffusion of impurity Zn into the active layer can be achieved. After the diffusion is completed, the dielectric film deposited on the surface of the sample is cleaned by wet etching with solutions such as hydrofluoric acid (HF), phosphoric acid (H3PO4), and then annealing is performed to eliminate lattice defects, impurities, stress and other defects introduced during the preparation process, thereby improving the stability and reliability of the prepared laser chip.

The diffusion of impurity Zn will produce a large number of defects. Under the action of defects, it will induce the mutual diffusion of atoms Al and atoms Ga in the quantum well and quantum barrier materials in the active region, thereby changing the forbidden band width of the region, thereby realizing the change of the laser output wavelength; while the portion without diffusion of impurity Zn has no change in its lasing wavelength.

In addition, by adjusting the type concentration, diffusion temperature, diffusion time, and other variables of impurity introduced (different materials, impurity Zn is introduced in the present application as an example), the forbidden band width of the material and the change of the lasing wavelength can be precisely controlled, thereby achieving a wavelength blue shift. Through theoretical calculations, for the GaInP/AIGaInP material system, the wavelength blue shift is 0.8 to 82 nm.

S140, a first electrode layer is formed on a side of the epitaxial layer facing away from the semiconductor substrate.

S150, forming a second electrode layer is formed on a side of the semiconductor substrate facing away from the epitaxial layer.

In some embodiments, laser units emitting light with different central wavelengths may be periodically arranged along the width direction of the laser chip. For example, the laser chip includes a first laser unit and a second laser unit emitting light with two central wavelengths, and the first laser unit and the second laser unit are arranged alternately in the width direction of the laser chip. In this way, the phase distribution of the laser light beam can be made more uniform, thereby reducing the appearance of dissipated speckles, making the brightness of the display screen more uniform, and reducing problems such as color difference. Meanwhile, the alternate arrangement can also improve the reliability of the laser display device, because if there is a problem with a laser unit of a certain wavelength, the laser units of other wavelengths can still work normally, thereby ensuring the stability and reliability of the device.

The laser chip provided in the embodiment of the present application forms at least two laser units capable of emitting laser light of the same color on one laser chip, and the first laser unit and the second laser unit emit laser light of different central wavelengths, so that the same one laser chip can emit laser light of different central wavelengths, effectively reducing the coherence between light beams, thereby reducing the speckle contrast of the projected image and improving the image quality. The active layer of at least one laser unit is doped using quantum well hybrid technology to form the second laser unit having the quantum well hybrid active layer, thereby increasing the forbidden band width of the active layer material of the second laser unit to change the central wavelength of the laser light emitted by it, and the widening of the forbidden band width can increase the optical catastrophic damage threshold, thereby reducing the occurrence of optical catastrophic damage to the second laser unit. Moreover, for at least one laser unit that has not been doped throughout the active layer, the non-absorption window is formed on its light-emitting cavity surface to obtain the first laser unit. Thus, without changing the central wavelength of the laser light, the band gap of the active layer at the light-emitting cavity surface is increased by using the non-absorption window, so that the band gap of the active layer at the light-emitting cavity surface is greater than the energy of the laser photons, thereby reducing the light absorption at the cavity surface, and reducing the occurrence of optical catastrophic damage to the first laser unit. In this way, the above process can reduce the coherence of the laser chip, improve the image quality, and reduce the occurrence of optical catastrophic damage to the laser chip. In addition, in the related art, a single laser chip is cleaved from a Bar array. The cleavage equipment is expensive and impurities are introduced during the cleavage process, causing the laser chip to be oxidized and damaged, affecting reliability.

In the present application, multiple laser units are prepared on the same laser chip, and can be obtained directly using Bar strips, thereby avoiding the use of cleavage equipment and reducing costs. In addition, since the Bar strip has multiple light-emitting points (laser units), compared with multi-chip lasers, its volume is smaller. When the volume is the same, it contains more laser units, making it easier to achieve high-power output of the laser. Similarly, in order to achieve the same output power as a multi-chip laser, the volume of the Bar strip array will be smaller, which is more conducive to miniaturized packaging.

In some embodiments, the doping materials and doping concentrations of the active layer of the first non-absorption window and the second laser unit are the same.

In some embodiments, the laser chip may include the second laser unit that emits laser light of the same central wavelength, and the laser chip may also include multiple second laser units that emit laser light of different central wavelengths. When the doping materials and doping concentrations of the first non-absorption window and the active layer of the second laser unit are the same, the first non-absorption window and the quantum well hybrid active layer of the second laser unit may be prepared under the same process, that is, the preparation of the first non-absorption window and the quantum well hybrid active layer of the second laser unit may be achieved simultaneously, thereby saving process flow and reducing process costs.

In some embodiments, the width of the first non-absorption window along the cavity length direction is 30 microns to 70 microns.

In some embodiments, the inventors have found that when the width of the first non-absorption window along the cavity length direction is less than 30 microns, the effect of the non-absorption window is not obvious, that is, the effect of improving optical catastrophic damage is not good; and when the width of the first non-absorption window along the cavity length direction is greater than 70 microns, the effective cavity length of the laser will be reduced, which will affect the output performance (mainly output power and efficiency) of the laser. Therefore, the width of the first non-absorption window along the cavity length direction is 30 microns to 70 microns, which can effectively reduce the occurrence of optical catastrophic damage and ensure the output performance of the laser.

In some embodiments, the active layer of the first laser unit further includes a second non-absorption window, the non-doped region is located between the first non-absorption window and the second non-absorption window, and the second non-absorption window is adjacent to and connected to the non-light-emitting cavity surface of the first laser unit.

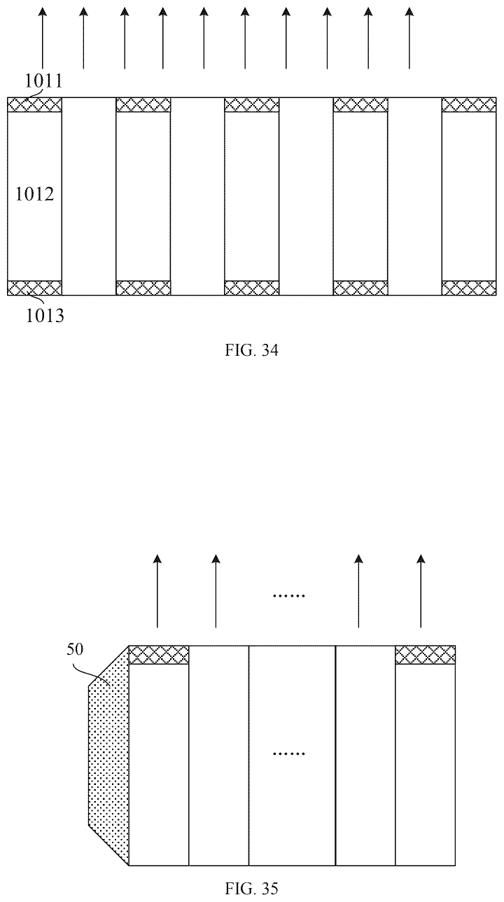

In some embodiments, the cavity surfaces at both ends of the laser unit can actually emit light. In order to meet product requirements and improve output performance, only one of the cavity surfaces needs to emit light, namely the light-emitting cavity surface, and the other cavity surface is the non-light-emitting cavity surface. In actual products, cavity surface masks need to be evaporated at both ends of the laser unit. A high-reflection film will be evaporated on one of the cavity surfaces so that the cavity surface does not emit light, namely the non-light-emitting cavity surface; and an anti-reflection film will be evaporated on the other cavity surface, namely the light-emitting cavity surface. Considering that if only the first non-absorption window is formed on the light-emitting cavity surface, it is necessary to distinguish which is the light-emitting cavity surface and which is the non-light-emitting cavity surface when evaporating the cavity mask, which requires the front and back order of the laser chip to be correct after cleavage. However, once the order is reversed, the high-reflection film will be evaporated on the cavity surface with the first non-absorption window, resulting in the cavity surface that actually emits light having no non-absorption window, which in turn causes the corresponding first laser unit to have optical catastrophic damage. To this end, in the embodiment of the present application, non-absorption windows are formed on both cavity surfaces, that is, as shown in FIG. 34, a first non-absorption window 1011 is formed on the light-output cavity surface, and a second non-absorption window 1013 is formed on the non-light-output cavity surface, so that there is no need to distinguish between the two cavity surfaces when evaporating the cavity mask, which can effectively prevent the first laser unit from optical catastrophic damage.

In some embodiments, the laser units are used to emit red laser light, where the difference between adjacent center wavelengths of the red laser light emitted by the laser units is 4 nanometers to 5 nanometers.

The inventors have found that when the difference between adjacent center wavelengths is less than 4 nanometers, the coherence between the corresponding lasers is strong, and the speckle problem is still more serious; and when the difference between adjacent center wavelengths is greater than 5 nanometers, the difficulty of growing red laser materials will be greatly increased, and the band gap of the active layer material with a shorter wavelength is higher, and carriers are easily leaked, affecting the output efficiency of the laser. Therefore, in the embodiment of the present application, the difference between adjacent center wavelengths is set to 4 nanometers to 5 nanometers for the red laser, which can effectively reduce speckle, reduce the difficulty of growing red laser materials, and ensure the output efficiency of the laser.

In some embodiments, the laser chip further includes at least one electrode welding portion, the electrode welding portion is located on at least one of a side surface and the non-light-emitting cavity surface of the laser chip, and the first electrode layer is electrically connected to the electrode welding portion.

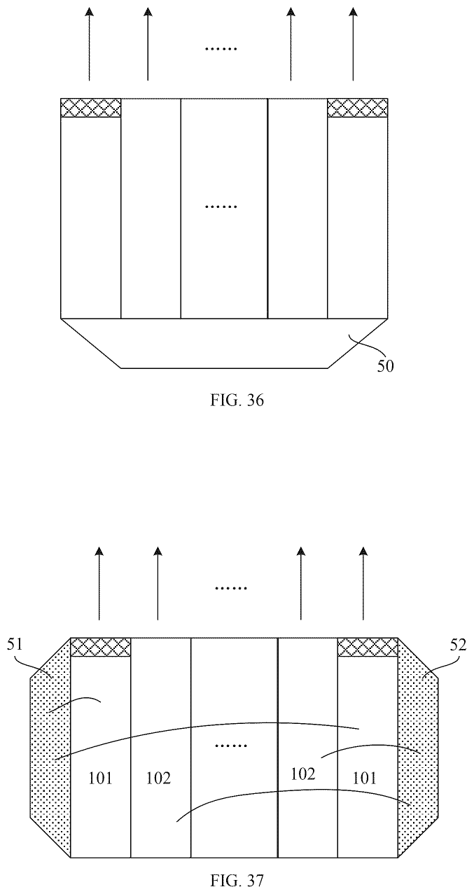

In some embodiments, the side surface refers to a side surface of the laser chip adjacent to the light-emitting cavity surface or the non-light-emitting cavity surface. As shown in FIG. 35, the electrode welding portion 50 is located on the side surface of the laser chip, or as shown in FIG. 36, the electrode welding portion 50 is located on the non-light-emitting cavity surface of the laser chip, or the side surface and non-light-emitting cavity surface of the laser chip are provided with the electrode welding portions 50. In this way, by providing the electrode welding portion 50 on the side surface and/or non-light-emitting cavity surface of the laser chip, the first electrode layer can be welded to the electrode welding portion 50 by gold wire, which can avoid welding stress and laser chip damage caused by welding the gold wire to the light-emitting cavity surface, greatly improve the reliability of the laser chip during welding, and improve the yield rate of the finished product. In the present embodiment, the shape of the electrode welding portion 50 is not limited, and can be a triangle, a quadrilateral, a semicircle, a semi-ellipse or a polygon.

In some embodiments, the first electrode layer includes a plurality of mutually independent first electrode blocks, and the first electrode blocks are arranged in one-to-one correspondence with the laser units. The first electrode blocks of the laser units emitting laser light of the same central wavelength are electrically connected to the same electrode welding portion, and the first electrode blocks of the laser units emitting laser light of different central wavelengths are electrically connected to different electrode welding portions.

Since the characteristics of laser units with different wavelengths are different, when the same current is injected, the output powers of the laser units will be different, resulting in uneven light emission. In order to make the output powers of the laser units the same, in the embodiment of the present application, the first electrode layer is divided into independent first electrode blocks, and each electrode block is correspondingly arranged in a laser unit, so that each laser unit can be driven separately, and then the first electrode blocks of laser units with the same lasing wavelength are electrically connected to the same electrode welding portion, and the first electrode blocks of laser units with different lasing wavelengths are electrically connected to different electrode welding portions. In this way, laser units with different lasing wavelengths can be driven separately, that is, laser units with different lasing wavelengths can be injected with different currents, so that the output powers of the laser units are the same, thereby improving the uniformity of light emission of the laser chip. As shown in FIG. 37, the laser chip includes a plurality of first laser units 101 and a plurality of second laser units 102. The first laser units 101 emit laser light of a first central wavelength, and the second laser units emit laser light of a second central wavelength. The first central wavelength and the second central wavelength are different. The electrode welding portion includes a first electrode welding portion 51 and a second electrode welding portion 52 independent of each other. The first electrode blocks of the first laser units 101 are electrically connected to the first electrode welding portion 51, and the first electrode blocks of the second laser units 102 are electrically connected to the second electrode welding portion 52. In this way, all the first laser units 101 can be driven by the first driving unit, and all the second laser units 102 can be driven by the second driving unit, so that the output powers of the first laser unit 101 and the second laser unit 102 are the same.

It should be noted that the laser chip provided in the embodiment of the present application can replace the light-emitting chip in the aforementioned light-emitting unit to provide a light source for the aforementioned light source chip. In addition, a laser light source adapted to a conventional laser projection imaging device can be manufactured based on the laser chip provided in the embodiment of the present application. For example, the manufactured laser light source can be used as the light source 10 in the conventional laser projection imaging device shown in FIG. 1 to reduce the speckle that may appear in the laser projection image and the optical catastrophic damage of the laser.

The laser light source made by the laser chip of the present application may include: a base plate, a tube wall, at least one laser chip provided by an embodiment of the present application, and a collimating lens group. The tube wall and at least one laser chip are both located on the base plate, and the tube wall is arranged around the laser chip, and the collimating lens group is used to collimate the laser light emitted by each laser unit in at least one laser chip.

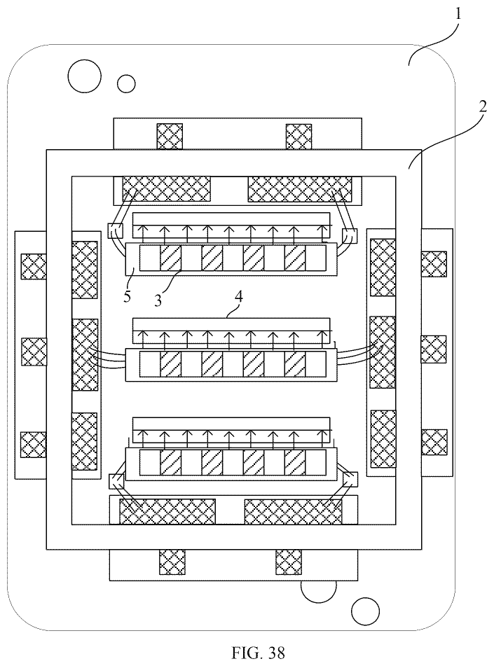

As shown in FIGS. 38 and 39, the laser light source can be a top-emitting laser light source, including: a base plate 1, a tube wall 2, at least one laser chip 3, at least one reflective prism 4, a heat sink 5, a transparent sealing glass 6, and a collimating lens group 7. Among them, the laser chip 3 is welded on the heat sink 5, the tube wall 2, the laser chip 3 and the reflective prism 4 are all fixed on the base plate 1, the laser chip 3 and the reflective prism 4 are surrounded by the tube wall 2, the transparent sealing glass 6 is sealed on the tube wall 2, and the collimating lens group 7 covers the transparent sealing glass 6. The laser light emitted by the laser chip 3 is reflected in the direction facing away from the base plate 1 through the reflective prism, and the reflected laser light is emitted perpendicular to the base plate 1 through the collimating lens group 7. In this embodiment, the base plate 1 and the tube wall 2 constitute a tube shell, and the material of the tube shell can be metal or ceramic. The collimating lens group 7 may include a plurality of collimator lenses, and the collimator lenses are arranged in one-to-one correspondence with the laser units, and are used to collimate the laser light emitted by each laser unit.

In some embodiments, the laser light source further includes at least one reflective prism, which is arranged in one-to-one correspondence with the laser chip, and the reflective prism is used to reflect the laser light emitted by the laser unit to the collimating lens group. Thus, by preparing a plurality of laser units with different lasing wavelengths on the same laser chip to form a laser array, a laser chip can be used to replace a plurality of laser chips arranged side by side in the related art, and then the patch accuracy of the laser units in the same one laser chip is the same. Therefore, there is no need to set a reflective prism for each laser unit. As long as a reflective prism is set, the laser light emitted by each laser unit on a laser chip can be reflected to the collimating lens group without deviation.

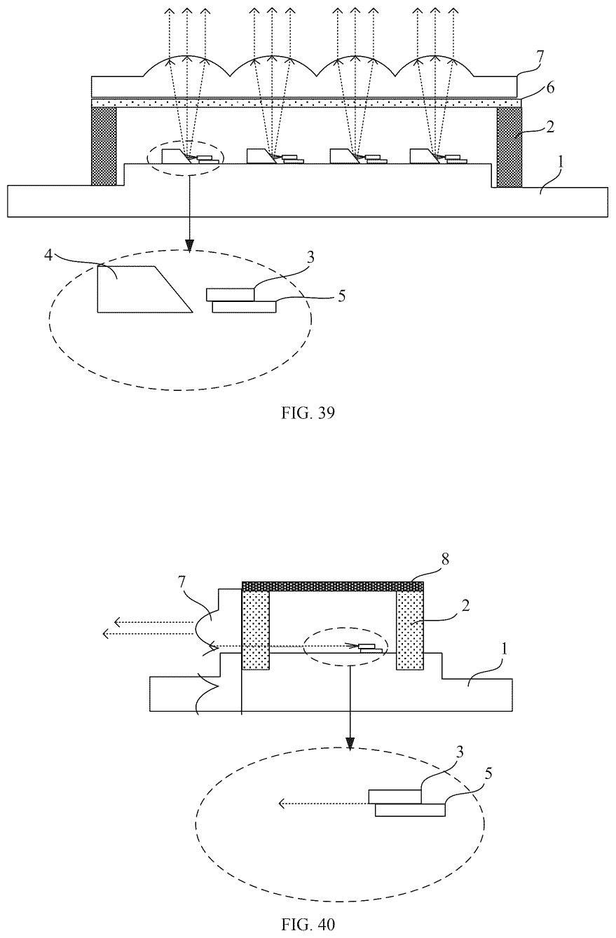

As shown in FIG. 40, the laser light source provided in the embodiment of the present application can also be a side-emitting laser light source, which does not require a reflective prism. It may include: a base plate 1, a tube wall 2, at least one laser chip 3, a heat sink 5, a collimating lens group 7, and a sealing cover 8. Among them, the laser chip 3 is welded on the heat sink 5, the tube wall 2 and the laser chip 3 are both fixed on the base plate 1, and the tube wall 2 is made of a transparent material, the laser chip 3 is surrounded by the tube wall 2, the sealing cover 8 is sealed on the tube wall 2, and the collimating lens group 7 is located on a side of the tube wall 2. The laser light emitted by the laser chip 3 directly passes through the tube wall 2 and then is emitted parallel to the base plate 1 through the collimating lens group 7.

What is claimed is:

1. A laser projection imaging device, comprising:
a light source chip, comprising a drive circuit and light-emitting modules; wherein:
the light-emitting module comprises a plurality of light-emitting units made of vertical-cavity surface-emitting lasers, and the light-emitting units comprise a first light-emitting unit for emitting red laser light, a second light-emitting unit for emitting green laser light, and a third light-emitting unit for emitting blue laser light; and
the drive circuit is electrically connected to the light-emitting units and is configured to:
receive a driving signal for displaying an image; wherein the driving signal comprises a target operating current representing display brightness of a video signal, a target adjusted pulse width representing display grayscale of the video signal, and light-emitting modules corresponding to the video signal; and
drive the light-emitting modules corresponding to the video signal according to the target operating current and the target adjusted pulse width, to cause that the light source chip emits laser light to form a target image;
a microlens array, located on a light-emitting side of the light source chip, and configured to homogenize light spots of the light-emitting modules; and
an imaging lens, located on a side of the microlens array facing away from the light source chip along a light beam propagation direction, and configured to receive light beams after passing through the microlens array and project the light beams into an image.

2. The laser projection imaging device according to claim 1, wherein the drive circuit is arranged in an array;
the drive circuit comprises first drive circuits each with a single output, each of the first drive circuits corresponds to a light-emitting unit and is electrically connected to the light-emitting unit, and the first drive circuit is configured to drive the light-emitting unit; and/or
the drive circuit comprises second drive circuits each with multiple outputs, each of the second drive circuits corresponds to a light-emitting module, an output terminal of a second drive circuit is connected to the first light-emitting unit, the second light-emitting unit, and the third light-emitting unit in the light-emitting module corresponding to the second drive circuit, and the second drive circuit is configured to drive the light-emitting module.

3. The laser projection imaging device according to claim 1, wherein each of the light-emitting modules comprises four light-emitting units, and the four light-emitting units are arranged in a 2×2 array.

4. The laser projection imaging device according to claim 3, wherein the four light-emitting units comprise:
two first light-emitting units, one second light-emitting unit, and one third light-emitting unit; or
one first light-emitting unit, two second light-emitting units, and one third light-emitting unit; or
one first light-emitting unit, one second light-emitting unit, and two third light-emitting units.

5. The laser projection imaging device according to claim 3, wherein the light-emitting units in the four light-emitting units are arranged in a 2×2 array are arranged along a first direction and a second direction; wherein the first direction intersects the second direction; and
light-emitting units arranged in the first direction are provided with different colors of emitted laser light; and/or light-emitting units arranged in the second direction are provided with different colors of emitted laser light.

6. The laser projection imaging device according to claim 1, wherein the light-emitting unit satisfies at least one of following configurations:
the first light-emitting unit comprises a first light-emitting chip based on a gallium arsenide substrate, a laser light wavelength of the first light-emitting chip is within 630 nanometers to 650 nanometers, and laser light wavelengths of different first light-emitting chips are arranged at equal intervals;
the second light-emitting unit comprises a second light-emitting chip based on a gallium nitride substrate, a laser light wavelength of the second light-emitting chip is within 515 nanometers to 540 nanometers, and laser light wavelengths of different second light-emitting chips are arranged at equal intervals; or
the third light-emitting unit comprises a third light-emitting chip based on a gallium nitride substrate, and a laser light wavelength of the third light-emitting chip is within 440 nanometers to 480 nanometers, and laser light wavelengths of different third light-emitting chips are arranged at equal intervals.

7. The laser projection imaging device according to claim 6, wherein an interval for the laser light wavelengths ranges from 3 to 5 nanometers.

8. The laser projection imaging device according to claim 1, wherein the microlens array comprises microlenses arranged in an array, and the microlenses are arranged in a one-to-one correspondence with the light-emitting units in the light-emitting modules; and
the microlens is configured to homogenize a light beam emitted by the light-emitting unit corresponding to the microlens.

9. The laser projection imaging device according to claim 8, wherein a material of the microlenses comprises at least one of sapphire, glass, or resin.

10. The laser projection imaging device according to claim 8, wherein a preset distance is provided between the microlens array and the imaging lens;
the microlens array is further configured to adjust a divergence angle of the light beam emitted by the light-emitting unit to cause that the homogenized light beam does not change a distribution of the target image; and
the light beam passing through the microlens array is irradiated into a light receiving surface of the imaging lens.

11. The laser projection imaging device according to claim 8, wherein the microlens array adjusting the divergence angle of the light beam emitted by the light-emitting unit is configured for:
when the divergence angle is less than a first angle threshold, expanding the divergence angle of the light beam to cause that the expanded divergence angle of the light beam is between the first angle threshold and a second angle threshold; wherein the second angle threshold is greater than the first angle threshold; and
when the divergence angle is greater than the second angle threshold, contracting the light beam to cause that the contracted divergence angle of the light beam is between the first angle threshold and the second angle threshold.

12. The laser projection imaging device according to claim 11, wherein the first angle threshold is 10 degrees and the second angle threshold is 12 degrees.

13. The laser projection imaging device according to claim 1, further comprising:
a base substrate, wherein the drive circuit is integrated and arranged on a side of the base substrate, and the light-emitting modules are located on a side of the drive circuit facing away from the base substrate.

14. The laser projection imaging device according to claim 13, wherein a material of the base substrate comprises at least one of glass, silicon, or sapphire.

15. The laser projection imaging device according to claim 13, wherein the light-emitting units are integrated onto the base substrate through mass transfer or micro-pipe technology.

16. The laser projection imaging device according to claim 13, wherein the base substrate is further integrated with an electrode, and the electrode is configured to drive the drive circuit.

17. The laser projection imaging device according to claim 12, further comprising:
optical elements, located between the light source chip and the imaging lens along the light beam propagation direction, and arranged in a one-to-one correspondence with the light-emitting units; wherein the optical elements are configured to reduce imaging speckle.

18. The laser projection imaging device according to claim 17, wherein the optical elements comprise at least one type of wave plates, compound eyes, or diffractive optical elements.

19. The laser projection imaging device according to claim 1, further comprising:
a computer controller, connected to the drive circuit; wherein the computer controller is configured to transmit the driving signal to the drive circuit for a to-be-projected image; and/or
a receiving screen, located on a light-emitting side of the imaging lens, and configured to receive light rays emitted by the imaging lens to display a projection image of the target image.

20. The laser projection imaging device according to claim 19. wherein the receiving screen is composed of multiple film layers, and the multiple film layers comprise a surface layer, a coloring layer, a diffusion layer, a lens layer and a reflection layer.
